(19) United States
(12) Patent Application Publication
(10) Pub. No.: US 2008/0291810 A1
(43) Pub. Date: Nov. 27, 2008

(54) Multi-Layer Three Dimensional Non-Linear Optical Data Carrier and Method of Recording/Reading Data Therein

(75) Inventors: Ortal Alpert, Jerusalem (IL); Yair Salomon, Jerusalem (IL); Ilya Rubinovich, Rehovot (IL)

Correspondence Address: BROWDY AND NEIMARK, P.L.L.C.;624 NINTH STREET, NW, SUITE 300, WASHINGTON, DC, 20001-5303, US

(73) Assignee: MemPile Inc. c/o PHS Corporate Services, Inc., Wilmington, DE (US)

(21) Appl. No.: 12/095,276

(22) PCT Filed: Nov. 28, 2006
(86) PCT No.: PCT/IL2006/001371

§ 371 Date: May 28, 2008

Related U.S. Application Data
(60) Provisional application No. 60/739,831, filed on Nov. 28, 2005.

(51) Int. Cl. G11B 7/24

(52) U.S. Cl. 369/275.3

(57) ABSTRACT

A non-linear optical data carrier is presented. The non-linear optical data carrier is configured for recording therein information defined by a pattern of spaced-apart marks arranged in virtual data layers. The data carrier medium comprises a sub-stance capable of being excited by a first multi-photon interaction to be switched from its first state into a second state, where the first and second states of the substance provide different response signals to a second multi-photon interaction. The substance when in the first and second states have substantially overlapping linear absorption wavelength peaks, and first and second wavelengths involved in the first and second multi-photon processes as well as the response signals wavelengths are outside the linear absorption spectrum peaks of the substance in its first and second states. The basic size of the marks and spaces is larger in the first than in the second layer. Data layers are recorded by monotically changing the focal plane depth of the recording beam.

### FIELD OF THE INVENTION

This invention is generally in the field of optical data carrier, and relates to a three dimensional non-linear data carrier, and a method of recording/reading data therein.

### BACKGROUND OF THE INVENTION

The existing approach for optical storage media is based on the use of reflective media. Accordingly, commercially available optical disks have dual-layer geometry, where the two layers are separated by a distance that is relatively large compared to the focal depth of the laser beam.

Patent Convention Treaty (PCT) publication WO 01/73779, assigned to the assignee of the present application, discloses a non-linear three dimensional memory for storing information in a volume comprising an active medium. The active medium is capable of changing from a first to a second isomeric form as a response to radiation of a light beam having energy substantially equal to first threshold energy. The concentration ratio between a first and a second isomeric form in any given volume portion represents a data unit. This PCT publication discloses an optical storage medium that comprises of diarylalkene derivatives, triene derivatives, polyene derivatives or a mixture thereof. An optical storage medium with photoactive groups has been disclosed in various PCT publications assigned to the assignee of the present application, for example WO 2006/0117791, WO 2006/075326, WO 2001/073779, WO 2006/075328, WO 2003/070689, WO 2006/111973, WO 2006/075327, WO 2006/075329.

The non-linear medium may be manufactured of monolithic plates and comprise various additives as described in PCT publication WO 2006/075329. Typically the recording process is more non-linear than the reading process. The use of such functional difference is also disclosed in PCT publication WO 2006/075329.

### SUMMARY OF THE INVENTION

The invention is directed to the processes of recording (writing) and reading of information in a multi-photon storage medium. These processes typically require large laser power density to record a pattern of spaced-apart marks for storing information on the medium. Further the quality of read signal obtained from the recorded marks depends on the modulation variation of the storage medium.

Optical systems performing the recording and/or reading processes are typically configured with a goal to focus the laser-scanning beam to a diffraction limited spot, corresponding to the “theoretical” smallest possible spot area. In practice, the minimal spot formed by an optical system is typically slightly larger than the theoretical diffraction limit as is measured by the optical transfer function. Consequently the term “diffraction limited spot” is assumed to cover the theoretical diffraction limit of the focus spot of the laser-scanning beam and the spots of about this theoretical diffraction limit. In order to record small marks arranged with high density and to achieve high data transfer rates, optical recording systems use various kinds of lasers having various power distribution patterns. Most of the laser sources including laser diodes naturally generate light of Gaussian power distribution pattern. The Gaussian pattern can then be transformed into other patterns, e.g. into a flat-top beam used in some conventional CDs, but such transformations are typically accompanied by loss of laser power. The loss or waste of laser power is undesired in the case of a non-linear optical medium, such as a two photon medium, in particular because recording and reading of such medium requires high power density, for example of the order of millions or billions of watt/cm².

Recording or reading with diffraction limited spot is very important as the non-linear interaction cross sections are very low and this can be achieved when the laser beam or its wave front propagates in a homogeneous medium. However, data and/or format marks in the carrier can have different optical properties (including a different refractive index, absorption and/or reflection profile) from that of blank medium. The non-uniformities of these optical properties alter the optical path and the wave front of recording and/or reading beam. This affects the ability of the optical system to create the diffraction limited spot, and the performance of the recording and reading processes. Typically the recording process is more non-linear than the reading process and thus more sensitive to aberrations.

Both the position of the focus spot and the light energy distribution of the focus spot are affected by the variations of the refractive index in the optical path of the beam. The beam can be represented as consisting of various rays propagating towards the focus spot, thus the variation between the optical path lengths between these various rays determines the wave front. The resulting focus spot is dependent on the cumulative effect done to the rays by the focusing optics and by the medium traversed by them.

As a general case, various rays (photons) pass through various amounts of recorded and non-recorded regions of the medium. Accordingly, the accumulated aberration of the focused spot relates to a variation between the rays' optical path lengths. The inventors have sought to decrease this variation and have found that this can be done for the recording process by using an ordered (non-random) recording strategy. Among various non-random recording strategies, the inventors select those that provide acceptable aberration of the focus spot as well as allow for conveniently realizable parameters of the overall setup.

Thus, the present invention provides a novel technique of data recording/reading in a non-linear optical medium, in the form of a three-dimensional pattern of spaced-apart data marks distributed in virtual layers in the medium. The technique of the present invention allows for significantly increasing a number of the effectively recordable and readable data layers, thus significantly increasing the amount of stored data.

It should be understood that the term “non-linear medium” used herein signifies a medium in which data marks are recordable by multi-photon absorption process, preferably simultaneous multi-photon (e.g. two-photon) process. As for the reading process, the medium may be of a kind in which the recorded data is readable by detecting a fluorescent signal from the medium excited by a (simultaneous) multi-photon absorption process.

The optical medium used in invention may be a non-linear medium comprising a photo-switchable, e.g. isomerizable, substance, in which the recorded data marks have a different state than their surrounding in the medium with respect to their optical interaction with the interrogating light. Preferably, the medium is selected such that the data mark region of the medium and its surrounding have an overlapping absorption peak of the linear absorption process, i.e. the medium composition in both isometric states have overlapping absorption peaks. The wavelengths of the interacting light (i.e. exciting light for recording and reading) are selected to be far from the main linear absorption spectra of the medium. The peak of the wavelength of the medium response light (fluorescence), excitable by the multi-photon absorption process (in a particular preferred case by a simultaneous two-photon absorption process) enabling reading (read signal), is preferably 50 nm, more preferably 70 nm, more preferably 100 nm longer than wavelength of a linear absorption peak of the medium.

The non-linear medium used in the present invention is substantially transparent to the exciting and excited wavelengths (those of reading, recording and fluorescence). A difference in the refractive indices between regions of the data marks recorded to the desired depth of modulation and surroundings of these regions (blank or non-recorded regions of the medium) is very small.

Appropriate selection of the medium and operating with an optimal recording strategy provide for creating a high number of data layers, for example 100 and more data layers in the medium, for a given fill factor which is preferably substantially the same for the multiple data layers.

According to the invention, the discrete data marks are recorded in all the data layers by illuminating the medium by a recording beam (e.g. pulsed beam) entering the medium from an upper surface thereof, while generally monotonically changing a focal plane depth of the recording beam in a certain general recording direction. This general recording direction may be from the upper to bottom surface of the medium or the opposite direction.

The expression “generally monotonically changing a focal plane depth of a recording beam” describes a non-random recording strategy suitable for use in the present invention. The use of such recording strategy is associated with the understanding of various factors affecting the focus spot quality during the recording and reading beams propagation through a medium. These factors include, inter alia, loss of the beam intensity due to absorption, reflection and scattering of the recording/reading beam at the medium and optics interfaces and medium non-uniformities, deviations in the angle of the recording/reading beam, possible diffraction of the beam at densely recorded information layers, other aberration effects. These various factors can lead to loss of focus spot intensity and focus spot aberration.

The above-described non-random recording strategy of the present invention facilitates eliminating or at least significantly reducing effects decreasing the beam focus quality. The recording strategy of generally monotonic change of a focal plane depth in a general recording direction can be implemented in at least three possible ways, two being of substantially monotonic change of the focal plane depth in opposite directions, respectively, namely when all the data layers are recoded one-by-one in the direction from the upper surface and in the direction from the bottom surface, and the other recording strategy being such that all the data layers are recorded by blocks each containing multiple data layers. In the latter case, the successive blocks are sequentially recorded while changing the focal plane depth in the general direction (from or towards the upper surface) while the successive layers in the block are recorded in the opposite direction or in an arbitrary manner.

Considering recording the data layers by blocks, a distance between each two locally adjacent blocks is preferably larger than a distance between the layers of the same block. An optical recording/reading system can include an aberration correcting optics which may be displaced or switched while changing the focal plane depth of the recording beam from block to block.

The recording strategy of the present invention allows for recording and, in some cases, reading multiple data layers with substantially constant intensities, respectively, of the recording and reading beams. This is not only convenient in use (e.g. decreases power waste, reduces requirements to the power dynamic range of illumination sources, allows for using smaller, cheaper, more reliable sources), but also prevents an undesired effect of recording during the reading process (graying effect).

Also, this recording strategy allows for creating substantially the same required depth of modulation in the data marks for all the data layers. In this connection, it should be noted that the expression “required depth of modulation for the data marks” signifies certain minimal depth of modulation that should be achieved in the marks and their surroundings. As will be described more specifically further below, the depth of modulation depends on the resolution and intensity of the recording process and the resolution of reading process.

There is thus provided according to one aspect of the invention, a non-linear optical data carrier for recording therein information defined by a pattern of spaced-apart marks arranged in virtual data layers, the data carrier comprising a medium comprising a substance capable of being excited by a first multi-photon process to be switched from its first state into a second state, where the first and second states of the substance provide different response signals to a second multi-photon interaction, the substance when in the first and second states having substantially overlapping linear absorption wavelength peaks, and first and second wavelengths involved in said first and second multi-photon processes and the response signals wavelengths being outside the linear absorption spectrum peaks of the substance in its first and second states, said non-linear optical storage medium allowing creation therein of the multiple data layers.

The response signal may be a fluorescent signal. Preferably, the wavelength of the (fluorescent) response signal is at least 50 nm longer than a wavelength of the linear absorption peak of said medium, or more preferably at least 70 nm longer than a wavelength of the linear absorption peak of said medium, or even more preferably at least 100 nm longer than a wavelength of the linear absorption peak of said medium.

The data carrier may contain multiple recorded data layers, each containing a plurality of spaced-apart recorded marks.

In some embodiments of the invention, the recorded marks are configured with substantially the same basic depth of modulation for the multiple data layers.

In some other embodiments, the recorded marks are configured with increasing basic depth of modulation in the data layers in a direction from the upper surface thereof (by which it is to be exposed to a reading beam). The increased basic depth of modulation may be implemented while with substantially the same basic size of the recorded marks and increased level of the fluorescent state concentration profile contrast in the multiple data layers in a direction from an upper surface of the data carrier by which it is to be exposed to a reading beam, and substantially the same basic size of the spaces, for the multiple data layers. Alternatively, the increased basic depth of modulation may be implemented with such a pattern of the recorded marks where the basic size of the mark is larger in a first data layer than in a second data layer more proximal to the upper surface of the medium; and/or with the basic size of the space being larger in the first data layer than in the second data layer.

The data layers may comprise an arrangement of blocks each including the multiple data layers. In this case a separation between the blocks is larger than a separation between the data layers of the same block.

The non-linear optical data carrier of the present invention may include about 35-70 of the data layers, or about 71-150 of the data layers.

According to another aspect of the invention, there is provided a non-linear optical data carrier for recording therein information defined by a pattern of spaced-apart marks arranged in virtual data layers, the medium comprising a substance capable of being excited by a first multi-photon process to be switched from its first state into a second state different in its optical interaction with a second multi-photon process, where the substance when in the first and second states have small absorbance dissimilarity.

According to yet another aspect of the invention, there is provided a non-linear optical data carrier for recording therein information defined by a pattern of spaced-apart marks arranged in virtual data layers, the medium comprising a substance capable of being excited by a first multi-photon process to be switched from its first state into a second state different in its optical interaction with a second multi-photon process, where the substance when in the first and second states have small absorbance dissimilarity, said non-linear optical storage medium having multiple recorded data layers configured with substantially the same basic depth of modulation for the multiple data layers.

According to yet further aspect of the invention, there is provided a non-linear optical data carrier for recording therein information defined by a pattern of spaced-apart marks arranged in virtual data layers, wherein the pattern of the recorded marks in at least one first layer and at least one second layer which is more proximal to an upper surface of the medium, by which the data carrier is to be exposed to a reading beam, than said first layer is characterized by at least one of the following: the basic size of the mark is larger in the first than in the second layer; and the basic size of the space is larger in the first layer than in the second layer.

The present invention also provides a method of recording data in a three-dimensional optical data storage medium, recordable by multi-photon absorption process, the method comprising illuminating the medium by a recording light beam, entering the medium from an upper surface thereof, while generally monotonically changing a focal plane depth of the recording beam in a certain general recording direction, to record a pattern of spaced-apart marks arranged in multiple virtual data layers.

Preferably, the recording of the multiple data layers is carried out with substantially constant intensity of the recording light beam.

In some embodiments of the invention, the recording of the multiple data layers comprises creating substantially the same basic depth of modulation for the multiple data layers. In some other embodiments of the invention, the recording of the multiple data layers comprises creating the basic depth of modulation for the multiple data layers substantially increased in a direction from the upper surface. The latter can be achieved by increasing a level of the fluorescent state concentration profile contrast in the multiple data layers in the direction from the upper surface, or by increasing the basic mark/space size in the data layers from the upper surface of the medium. The increase of the level of the fluorescent state concentration profile contrast may be achieved by recording with a longer recording event and/or longer time gap between the recording events, and smaller speed of a relative displacement between the recording beam and the optical medium when recording in the at least one first layer than in the at least one second layer. The increase in the basic mark/space size can be achieved by recording with a longer recording event and/or time gap between the recording events, and substantially the same speed of a relative displacement between the recording beam and the optical medium.

The cording may be conducted by successively recording multiple blocks of the data layers while monotonically changing the focal plane depth of the recording beam in between the blocks in said general recording direction. The recording of the multiple data layers may comprise recording the data layers of the block arbitrarily changing the recording direction. Preferably, aberration correcting optics is displaced (readjusted) while changing the focal plane depth of the recording beam from block to block.

The generally monotonically changing the focal plane depth may comprise monotonically changing the focal plane depth in the general recording direction, which may be a direction from the upper surface towards a lower surface of the medium, or from the lower towards upper surface of the medium. Preferably, a width of the recording beam is selected to be larger than a width of a beam to be used for reading the data layer.

In yet another aspect of the invention, there is provided a system comprising data-carrying optical medium as described above and 4-quad APD configured to detect fluorescent light excitable by the simultaneous multi-photon absorption process enabling reading.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a schematic illustration of a cross section of disc-like shaped non-linear optical storage medium.

FIG. 2 is a top view of disc-like shaped non-linear optical data carrier of FIG. 1.

FIG. 3 is an expanded view of a recorded section of the non-linear optical data carrier.

FIGS. 4A to 4C show three examples, respectively, of the optical data carrier of the present invention with the recorded data marks therein;

FIGS. 5A and 5B exemplify a recording strategy in a non-linear optical data carrier according to the invention.

FIGS. 6a-6e show the results of simulation of some effects relevant to the light propagation through a medium with recorded data layers.

FIGS. 7A-7C and 8A-8B illustrate schematically two optical medium structures, respectively, used in the experiments.

FIG. 9 show the experimental results for the depth of modulation achieved with the technique of the present invention.

FIG. 10 illustrates the optical properties of the medium suitable to be used in the data carrier of the present invention.

### DETAILED DESCRIPTION OF THE INVENTION

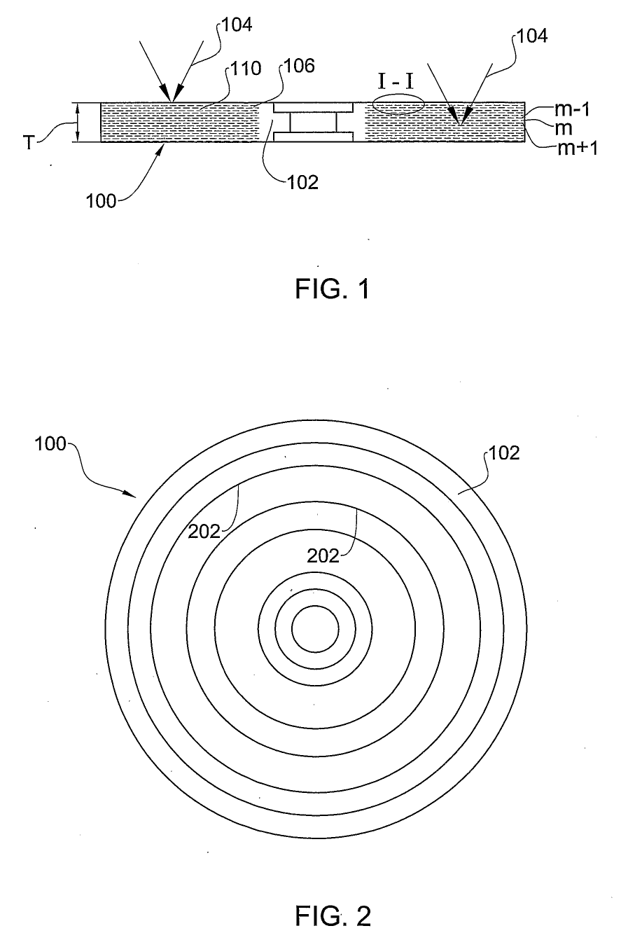

Reference is made to FIG. 1 showing a cross section of an exemplary embodiment of a three-dimensional optical information carrier, generally designated 100. Carrier 100 may be a monolithic disc-like body or an assembly of plates made of a transparent or translucent polymer material 102, such as Polymethylmethacrylate (PMMA) and compositions including acrylate and methacrylate monomers. An active moiety, capable of changing its state from one isomeric form to another upon interaction with electromagnetic energy, such as laser radiation 104, is bound to polymer 102. The information is recorded on carrier 100 as a three-dimensional (3D) pattern of marks 110. Marks 110 may include spherical or oblong or oblong and tilted shape marks. In addition to optically recorded data marks representing the information, a pattern of servo or formatting marks (not shown) may be embossed or optically recorded on carrier 100. The shape of formatting marks may be similar or sometimes identical to data marks.

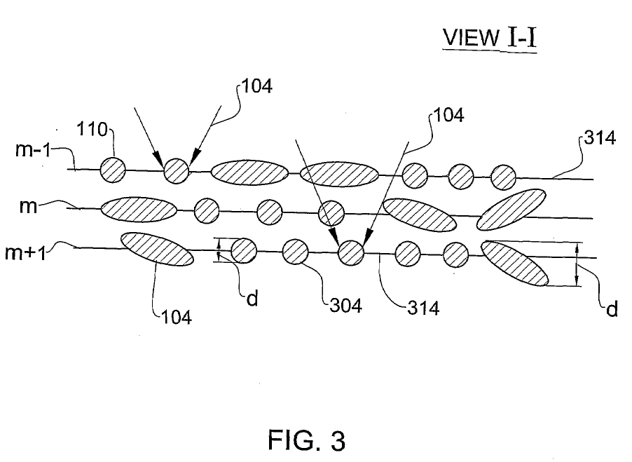

Marks 110 are optically recorded in carrier 100 in practically any location, although it is convenient to record them on a plurality of “virtual” layers 106. Typically, marks 110 are recorded along so called data tracks 202 (FIG. 2) which may be circular or spiral tracks. There is a certain distance between marks 110 disposed on the same track and between two adjacent tracks (track pitch). The distance between two adjacent tracks or track pitch may be in the micron range. A certain distance between the recording layers 106 disposed along the axial dimension (the thickness) of medium 100 also exists. The thickness of the medium T between the first and last recorded layer or marginal layers that may be recorded is usually termed active thickness.

It is desired to effectively record as many as possible data layers (“effectively” meaning recording enabling further data reading with sufficiently high signal to noise ratio). In principle, hundreds of layers can be introduced in a couple of mm thick medium (1-6 mm). The present invention utilizes recording, within a data layer, the data marks of various sizes, as well as spaces between them. As for the marks' shape, they may be oblong or tilted. The data recording may utilize the principles of the so-called Run Length Limited (RLL) data encoding technique. For example, the data marks may be of 2T, 3T, . . . nT sizes (where T is measured in length units or corresponding clock ticks) and correspond to different bit sequences. A pattern formed by the marks and spaces is indicative of the information, i.e. the spaces between the marks contribute to the information as well. The spaces may be for example of sizes 2T′, 3T′, . . . , nT′. Preferably, the increase in the data mark sizes is the same for different bit sequences. This increase equals T in the above example. The data encoding may use the so-called symmetric scheme, meaning that T=T′. The encoding scheme may also include additional features, for example it may require controlled statistical frequency of occurrence of the marks and or spaces of certain sizes, e.g. DC free encoding.

Considering the non-linear optical medium, the data recording and reading processes should enable multiple reading of the same recorded data. As for the data reading process, it is performed by illuminating the medium e.g. with a sequence of short pulses, and detecting a non-linear fluorescence response of the medium. The recoding process is aimed at defining the sizes (lengths) and shapes of the data marks and the sizes of the spaces (to correspond to the encoded data). The reading process is aimed at identifying those sizes and shapes and spaces to identify the stored data. The latter is determined inter alia by depth of modulation in the detected read signal sequence. The length of the mark (or the length of the space) is determined by a time distance between two successive rise-and-fall and fall-and-rise events in the intensity of the read signal. The recording strategy is selected to provide effective recording (i.e. enabling data encoding and further reading), based on the understanding of the behavior of a light beam (recording and reading beams, and a fluorescence response) while propagating through the medium. The recording strategy should provide creation of substantially the same required basic depth of modulation of the medium, containing the data marks and spaces, for all the data layers. In this connection, the following should be understood:

Depth of modulation is typically defined as the ratio:

$$M = \frac{{P}_{MAX} - {P}_{MIN}}{{P}_{MAX}}$$

wherein P_{MAX} and P_{MIN} are the intensities of the fluorescent response from, respectively, the recorded data mark and the blank region (space); or in certain cases as the ratio:

$$m = \frac{{P}_{MAX} - {P}_{MIN}}{{P}_{MAX} + {P}_{MIN}} ,$$

the relation between the two definitions being:

$$m = \frac{M}{2 - M}$$

The depth of modulation of a reading process depends on such parameters as the resolution of detection of a read signal and the intensity profile of the detected read signal. The intensity profile of the detected read signal (fluorescent signal) is determined by the recorded data mark shape (size and geometry), a distribution of the local effect of recording (state concentration profile) within the data mark, as well as the distribution of the intensity of the reading beam at focus.

The depth of modulation is characterized by the specifics of the recording and reading processes, in particular the non-linearity of these processes, and is probed by an optical transfer function (OTF). The fluorescent signal contrast would rapidly decrease for marks of a size around and below the diffraction limit of the optical system. This is because the OTF would provide the read signal from the smaller marks that are below the resolution being in less contrast to the spaces, as the signal is starting to be collected also from the surrounding space. For non-aberrating medium and optical system, this limit is around the diffraction limit. Signal to noise ratio (SNR) is monotonic with the modulation depth. Recording larger (longer) marks can provide an increase in the SNR of the read signal.

It should be noted that one of the properties of recording oblong or tilted mark in monolithic medium is that the refractive index change (if any) of the recorded mark is not abrupt (as for example is the change between physical layers), this is because the switching between the concentration ratios of the at least two states between a mark and the space surrounding it is continuous for oblong marks, the state concentration profile being typically approximately Gaussian, thus reflection and scattering from marks is insubstantial. Recording with oblong or tilted marks could affect the read signal, as will be described more specifically further below.

Considering the above explanation of the fluorescent signal contrast dependence on the OTF and the marks-spaces pattern, as well as the principle of RLL recording, the inventors have found that it is appropriate to control the depth of modulation of the medium marks and spaces by controlling that of the marks of a mark basic (minimal) size and spaces of a space basic (minimal) size in a data layer. As indicated above, marks of various sizes and spaces of various sizes are used in optical storage for purposes data encoding (as well as servo signaling and system) using a finite, discrete set of sizes. Considering the above example, the basic mark size and the basic space size would be 2T and 2T′, respectively. The longer or larger marks would be further from the diffraction limit and would thus provide higher OTF. Hence, these are the smallest mark and the smallest space used by system in a specific layer, that give the smallest modulation depth (and the lowest SNR) amongst all the mark types and space type used in that layer. The modulation depths of these smallest (basic) marks and the smallest (basic) spaces, in the working system, should be equal or larger than the minimal required depth of modulation for that layer. The smallest mark and its modulation depth also sufficiently reflect the channel capacity of this layer, which is directly related to how many minimal marks and spaces can be recorded in this layer.

Thus the “required depth of modulation for the data marks” in a certain layer can be defined in several ways of which it is convenient to refer to the depth of modulation of the basic (smallest) mark used in that layer, taking into account the intrinsic aberrations of the reading beam and read signal while in the optical data carrier, e.g. media imperfection and as will be elaborated below intrinsic aberrations formed by the data layers.

For the reading process in a multi-layer optical medium, which process involves a reading beam to pass through one or more data layers, it results in a decrease of the reading beam intensity at focus and in some cases in a decrease of the reading resolution (increase of the width of the reading beam at focus). These effects depend on the optical properties of the medium used (refractive index pattern, absorption, scattering, etc.). The inventors have found that in media where a difference in the refractive indices between the data mark and space regions is very small (resulting in small aberrations per layer), the decrease of the beam intensity at focus becomes a more prominent effect affecting the performance of the reading process.

The inventors have found that a partial compensation for the above effects can be provided during reading by increasing the reading beam intensity for the lower layers as compared to that of the upper ones. However, appropriate selection of the recording strategy allows for performing the reading process with substantially the same intensity of the reading beam.

The inventors have further found that the above effect can be at least partially compensated for by carrying out a recording process with varying conditions for the recording events in a direction from the upper to bottom surface of the medium. This can be implemented in two ways: by increasing the local effect of recording and by “coarsening the resolution” meaning increasing the basic size of the mark and/or space as described above. The increasing of the local effect of recording (fluorescent state concentration profile contrast) can be achieved by a longer recording event within the same data mark size, which results in an increased local concentration of isomerized chromophores. Practically, this can be obtained by appropriately controlling the relative displacement between the medium and the recording beam (e.g. decreasing the speed of the medium rotation). The increase in the basic size of the mark and/or space can be achieved by prolonging the recording event so as to allow the increase in the mark/space size (e.g. prolonging the recording event for the given speed of the medium rotation).

Regarding the recording process, if it progresses from the upper surface to the lower surface of the medium, the above described effects (decrease of intensity at focus and in some cases increase in the width of the recording beam at focus) are relevant for the recording beam as well. Thus, generally, the increase in the local effect of recording (with the same mark size) may be achieved by increasing the intensity of the recording beam. However, the inventors have found that using the appropriate non-random recording strategy (as will be described more specifically further below) allows for convenient and thus preferred recording of the multiple data layers with substantially constant intensity of the recording beam.

It should also be noted that the recording beam might be more sensitive to these effects because the recording process could be of a higher degree of non-linearity than a reading process. Alternatively, the recording process may progress in a direction from the bottom to upper surface of the medium.

Thus, generally speaking the recording strategy utilizes a generally monotonic change of a depth of focusing in a certain general recording direction. An example of the generally monotonic recording strategy is a recording from bottom to top, in which multiple layers are recorded successively recorded one by one.

With regard to the non-linear optical medium it is of the kind in which data is recordable by a simultaneous multi-photon absorption process, and preferably, readable by a simultaneous multi-photon absorption process. This medium may for example include an isomerizable substance, in which the recorded data marks have a different isomerization state than their surrounding in the medium. There are several mechanisms of non-linearly accessing a non-linearly responsive material, of which two-photon absorption is preferred, other processes such as combining two-photon absorption with additional absorption of the excited state (He et al., J. Phys. Chem. A, 104, 4805-4810, 2000) are also known in the art. The methods of recording and the structure of the optical medium described herein apply to such materials as well. An aspect of the invention is utilizing the ability to record in a pre-designed order (i.e. with a predetermined recording strategy) to overcome the described problem of aberration introduced by recorded layers to a focused spot of a light beam in the wavelengths used for recording and then reading using second wavelengths which may be the same as a recording wavelengths, having the one or more read beams undergoing reduced/controlled amount of aberrations.

Considering an optimal recording strategy, various factors of the recording beam propagation through the medium should be taken into consideration. The following is the explanation of various mechanisms that might affect the recording beam propagation.

Let us consider the recording process progressing in a direction from the upper surface of the medium (i.e., that closer to an optical recording unit). In this case, the currently recorded data layer is accessed by the recording beam through the medium volume containing preceding recorded data layers thereabove.

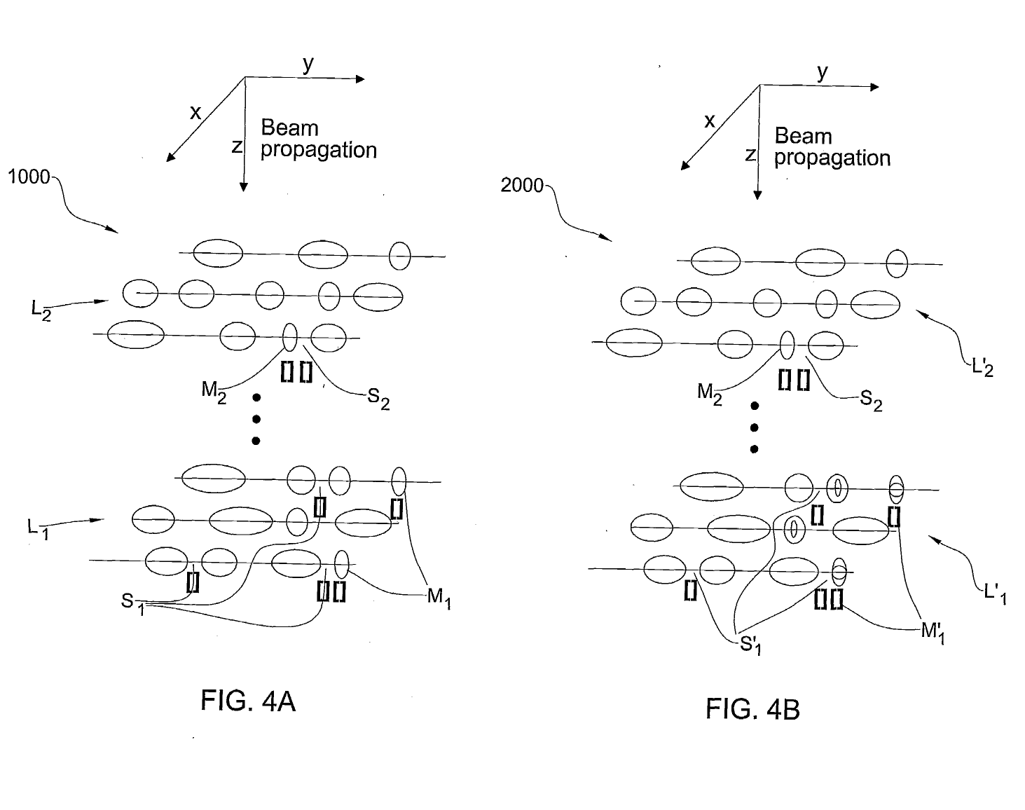

There may be a difference in the refractive indices of the recorded volume or marks and non-recorded or blank sections of polymeric material 102. As shown in FIG. 3, these differences, even if being small, in the refractive index of recorded sections (marks 110) and blank sections of medium 102 would alter the optical path and the wave front of recording and/or reading beam 104. The optical path (wave front) alterations affect the performance of the recording and reading processes.

Recording and reading data on a non-linear optical medium and particularly on a multi-photon (e.g. two-photon) medium requires significant laser power density. To reach this density the recording and reading processes are typically performed by a diffraction limited spot, and by a laser beam with Gaussian power distribution. Formation of a diffraction limited spot is possible if the photon (ray) optical path or wave front is distorted less than a quarter wave ¼λ. Since the accumulated wave front error is a sum of the optical (photon, ray) path difference introduced by the focusing optics and by medium 102 traversed by the laser beam, the wave front distortion error introduced by each of them should be smaller. Established practice suggests medium 102 introduced distortion limits lower than 0.25λ or even less than 0.1λ, where λ is the wavelength of the recording/reading laser, although practical considerations show that for a non-linear optical storage medium a limit of 1λ is acceptable.

Generally, in a blank medium, such as medium 102 (FIG. 1), it is possible to meet this requirement. However, as illustrated in FIG. 3, which is an expanded view of a recorded section of the non-linear optical storage medium 100, when a reading or recording laser beam 104 operates on the (m+1) layer, it propagates through a number of m recorded layers. For demonstration purposes, only three layers are shown in the figure. Laser beam 104 meets marks 110 having different index of refraction than the rest of medium 102. Optical path length of a ray passing through a recorded mark is different from the optical path of a ray that does not pass through a recorded mark. Optical path length is the product of the geometrical distance traveled by the ray and refractive index.

If the difference between the refractive index of a recorded sections or mark 110 and the refractive index of blank or non-recorded sections 102 of medium 100 is Δn and the relevant effective dimension of mark 110 is d, subsequently the phase change of a particular photon (ray) 304 passing through a single mark or layer as compared to a photon (ray) passing through blank areas of medium 100 may be expressed as 2πd*Δn/(λ). In this expression d*Δn is the effective optical thickness of the mark. The phase change, as illustrated by rays 314 would be especially significant for high numerical aperture optics. In a practical case when focusing laser (light) beam 104 on the (m+1) layer, light beam 104 has to pass through m layers preceding layer m+1 in the beam propagation direction. Each photon (ray), on its way to the m+1 layer, will pass through recorded marks and non-recorded sections of medium 102 until it reaches the m+1 layer. If the statistical probability of a photon (ray) to meet a recorded mark in a single layer is P then each photon (ray), on an average will pass through m*P recorded marks.

Not all photons (rays) will pass throughout the same amount of recorded and non-recorded sections of medium 102. Accordingly, the statistical variation of the optical path length for photons passing through recorded marks will be in a first approximation proportional to (m*P*(1−P))^{1/2}. In a dense recording medium the thickness of a single recorded layer is close or equal to d the effective optical thickness of the recorded mark. The above expression does not account for the additional disturbances introduced by certain reflection of the reading/recording beam, diffraction caused by densely recorded information layers, variations of the angle of the reading and recording beams that would most probably make the variations in the phase of the photons (or rays or wave front) passing through all m layers slightly larger. (Through the text of the present application optical wave front phase change is sometimes measured in absolute phase change units and where convenient or conventionally established in fractions of the wavelength e.g., λ, ¼λ, 0.15λ. To translate between these two presentations multiply the absolute phase change by λ/2π, a phase change variation of 2π corresponds to 1λ.) In order to maintain diffraction limited spot through a medium 102 with a plurality of recorded layers, the value of the above expression should be smaller than 1λ or smaller than 0.25λ and even better if it would be smaller than 0.05λ. The other disc-like parameter of interest is distance L between two adjacent recoded layers (e.g. m−1 and m or m and m+1), which is comparable or of the same order as the recorded mark 110 dimension d. It is reasonable to assume that the distance L is equal to recorded mark 110 dimension d or larger than d.

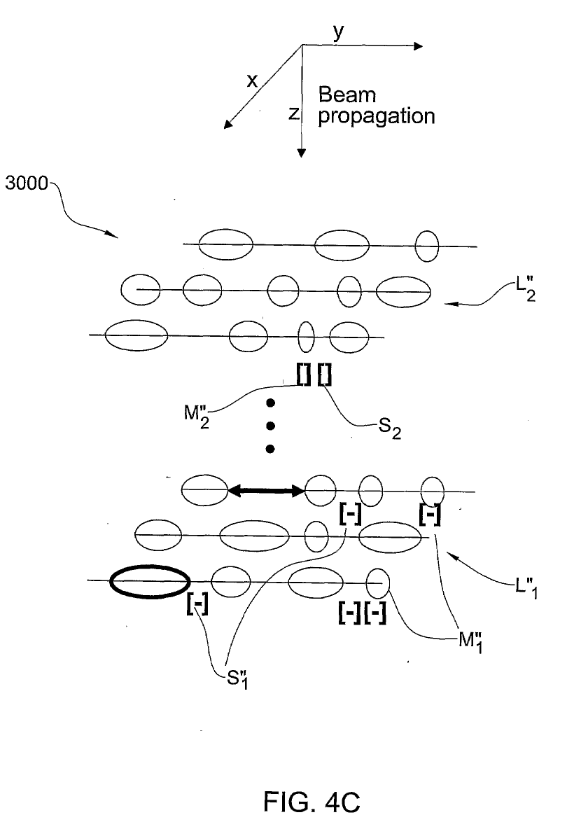

In order to record the multiple data layers while scanning the recording beam in a general recording direction through the medium, the recording strategy may be selected so as to record data with substantially the same basic size of the mark/space for the multiple data layers. In this case, the basic size data marks and the basic size spaces can be encoded such as to provide substantially the same depth of modulation of the medium in all the layers. This is exemplified in FIG. 4A, showing an optical data carrier 1000 with multiple recorded data layers, two such layers L₁ and L₂ being shown in the figure, where layer L₂ is located closer to the upper surface of the medium. As shown the basic sizes of the data mark M₁ and space S₁ for layer L₁ are substantially the same as the basic data mark size M₂ and space S₂ for layer L₂ and substantially the same state concentration profile (local effect of recording) for the basic marks in layers L₁ and L₂. In this case, in order to obtain the desired depth of modulation for a reading process, the reading process intensity would have to progress from the upper surface of the medium (that closer to an optical system) towards the bottom surface of the medium. This solution might be preferred over recording with increasing intensity towards the lower layers.

FIGS. 4B and 4C exemplify the data carrier configurations suitable to eliminate a need for reading with increasing intensity towards the lower layers. FIG. 4B shows an optical data carrier 2000 with multiple recorded data layers. Two layers L′₁ and L′₂ are shown in the figure, where layer L′₂ is located closer to the upper surface of the medium (towards the light source). This configuration is generally similar to that of FIG. 4A, namely the basic sizes of the data mark M′₁ and space S′₁ for layer L′₁ are substantially the same as the basic data mark size M′₂ and space S′₂ for layer L′₂. However, in the device 2000, in distinction to the above-described device 1000, the marks in layer L′₁ are recorded with the higher average state concentration profile (local effect of recording). This can be achieved by recording layer L′₁ with recording conditions different from that of layer L′₂, namely recording layer L′₁ with the so-called “more intensive recording” achievable by a longer recording event and by a lower speed of a relative displacement between the medium and a recording beam (e.g. with slower rotation of the medium).

Thus, in the above example of FIG. 4B, the effect of a decrease in the intensity of the reading beam at focus when focusing deeper into the medium is at least partially compensated for by increasing the contrast of the read signal due to the higher fluorescent state concentration profile contrast within the deeper layers.

FIG. 4C shows an optical data carrier 3000 resulting from a different recording strategy where data is recorded with varying basic size of the mark/space for the multiple data layers. The multi-layer optical data carrier 3000 is shown, two layers L″₁ and L′₂ being seen in the figure, where layer L″₂ is located closer to the upper surface of the medium. Here, the basic sizes of the data mark M″₁ and space S″₁ for layer L″₁ are larger as compared to those M″₂ and S″₂ for layer L″₂. This can be achieved by recording the deeper layers in the medium with a longer recording event and substantially the same speed of the medium rotation m. Thus, in this case the effect of a decrease in the intensity of the reading beam at focus when focusing deeper into the medium is at least partially compensated for by increasing the intensity and therefore contrast of the read signal due to the larger size of the data mark. It should be noted that in a partially recorded carrier the upper layers would provide better modulation that would allow easier data retrieval.

It should be noted that the principles of the recording strategies used in the examples of FIGS. 4B-4C could be combined (i.e., recording deeper layers with both larger basic sizes and higher local recording effect). With any of these recording strategies, the reading may utilize increased intensity for reading deeper layers. The inventors selected the preferred minimal depth of modulation to be about 0.1 preferably 0.15 more preferably about 0.3 most preferably higher then 0.5 and the variation in the modulation depth to be about 50%, more preferably 25%, and even more preferably 10%.

As it has been mentioned, the medium may be formed by two or more monolithic plates, bonded to each other, and having recordable or embossed reference layers in between. In such cases, physical interfaces between the monolithic plates can cause a sharp increase in the effect of aberrations of the beam passing through. This, in its turn, may decrease the SNR, which is, dependent not only on the modulation depth, but also on the signal amplitude. The inventor's recording and reading strategies and media are adaptable for such cases as well. In particular, the inventor can set its own required modulation depth for each monolithic plate, thus compensating for the decrease in intensities of recording and reading beam at focus. Within such an adapted approach, the invention provides for a required modulation depth profile generally block-wisely increasing towards the bottom. Blocks may be for example 20, 50 and even 100 layers thick.

Either one of the above effects of varying the recording conditions can be achieved by various recording strategies which are based on recording with a generally monotonically change of a depth of focal plane of a recording beam in a general recording direction. This can be implemented using the recording strategy such that the multiple data layers are recorded in the general recording direction from at least one first layer to at least one second layer, where the second layer is closer to the upper surface of the medium than the first layer. In other words, the recoding process proceeds from the bottom to the upper surface of the medium. The multiple layers recorded from bottom to top may be all the layers in the medium, recorded monotonically changing a depth of focal plane from bottom to top, or multiple blocks of layers, where the multiple layers of each block are recorded from bottom to top thereof while recording the successive blocks in the opposite, general recording direction. These are the recording strategies using generally monotonic change of the depth of focal plane.

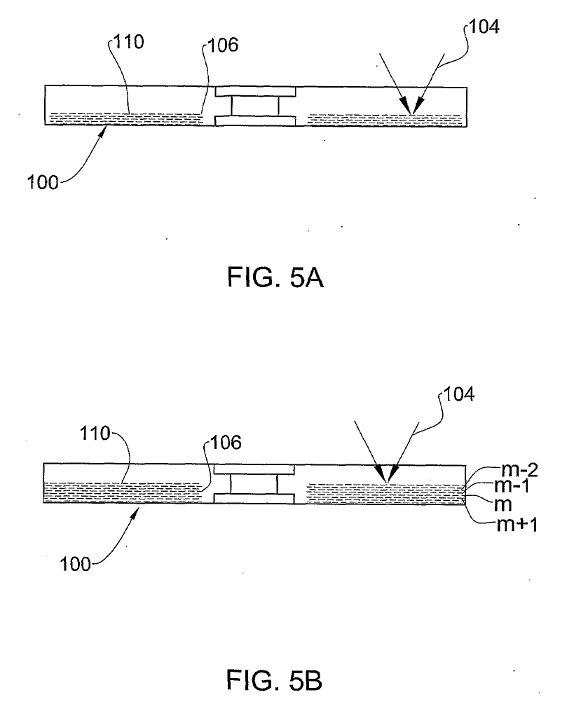

The above recording strategy (from bottom to top) is exemplified in FIGS. 5A and 5B, where the recording of data begins from layer m+1 and progresses to layer m, m−1 and so on.

With regard to the data reading process, the following should be noted. The reading has to be performed from any recorded layer, and a 50% increase in the reading spot size severely reduces the reliability or the data reading process and data transfer rates. Furthermore, if the reading mechanism involves a non linear optical process requiring high photon density, an increase in the spot size reduces the useful signal and reduces the signal to noise ratio.

Non-linear optical storage medium and particularly two-photon medium supports multiple data erasing/recording; a layer or a number of layers disposed between previously recorded layers may be erased and new (different) information may be recorded in place of the erased layers. In such case, recording laser beam 104 has to penetrate a number of layers preceding the erased section and having different indices of refraction.

Practical data recording considerations allow working out a refractive index changes limited recording method, establish an optimal distance between adjacent recorded layers and an active thickness of the non-linear optical data carrier. In free, not bound by particular recording layer, recording in a two-photon medium would result in a layer thickness of two to four times larger than the appropriate dimension of recorded mark 110 (FIG. 3). The physical size of recorded mark 110, which may be between 0.5 to 15 micron, is comparable with the recording light beam wavelength and typically the thickness of a recording layer in a medium which does not impose limitations on the thickness of the layers, could be expressed as d/λ=1-20. It is however desirable to work at the lower ratios such as 2 or 5. Non-linear optical storage medium is a densely recorded medium and the probability of a laser beam to meet a recorded mark is between P=0.1-0.7 (per layer) depending on the amount of recorded data and more typically it is between 0.2-0.4 for a recorded layer. In the context of the present disclosure, recorded mark means a data or a servo mark that is not necessary located on the recording track and not on the same virtual layer (or surface) formed by the data marks, (see for example WO2005015552 and WO/2006111972). In this context it is valid to consider P as the chance of passing through a recorded mark in a thin volume of the disk as the structure of the disk may be more complex than simple layers and the basic logical unit may be a block comprising a thickness that may allow for several layers e.g. 2, 4 or 6 layers thick.

The allowable refractive index change condition for optimal medium may now be formulated in general form as 2π*(d/λ)*(m*P*(1−P))^{1/2}*Δn<1*2π, where the right hand side is an absolute phase change and that the 2π factor may be cancelled out. Assuming the range of the d/λ ratio to be 1 to 20 and the probability of meeting a recorded mark in a single layer P=0.1-0.7 the refractive index change enabling recording of m layers should not be larger than 1*(m*0.7(1−0.7)^{1/2}*Δn<1. As stated earlier for better results it is desirable that the wave front (photon path) distortion would not exceed 0.25λ or even 0.15λ, or even 0.05λ.

This relation allows estimating the limits of the refractive index changes that support maximal possible number of recoded layers 106 in a non-linear optical storage medium. Accordingly, selecting extreme values of the parameters listed, the largest allowable value of refraction index change would result in the lowest number of recorded layers in a medium. The number of recorded layers 106 may be increased if lower values of refractive index changes causing smaller wave front distortion could be achieved.

Measuring the optical properties of a blank disc-like medium that include measurements of refractive index changes or equivalent measurement in the row material it is possible to determine which of the blanks would have higher capacity than others blanks. The maximal number of layers that could be recorded in the medium defines medium capacity. The method could be used in a production quality control process.

Hence, the medium is preferably selected such that the difference in the refractive index between the recorded sections (marks 110) of medium 100 and non-recorded sections of medium 102 does not exceed 1/(K*(maximal number of recorded layers)^{1/2}), where K is a constant proportional to the refractive index change, number of recorded layers, probability of hitting a recorded mark and some other factors/properties that affect light propagation through non-homogeneous material.

As the number of layers in the medium supported by the minimized refractive index changes and the distance between the layers become known, the method further supports determination of the active thickness T of a three dimensional optical storage medium 100, which is the distance between the first and last (marginal) recorded layers. Assuming that the distance between two adjacent recorded layers 106 is equal to the relevant recorded mark 110 dimension, the active thickness T would be a product of the number of layers m and the distance L between two adjacent recorded layers 106. Thus, the active thickness T, or distance between the marginal layers, is equal or smaller than L multiplied by (K*(the difference in the refractive index between the recorded and not recorded sections of the medium))².

As mentioned above, the appropriate selection of a non-random recording strategy is based on the understanding of various effects affecting the recording beam propagation through the medium and its effect on the data marks' pattern which in turn determined the performance of the reading process.

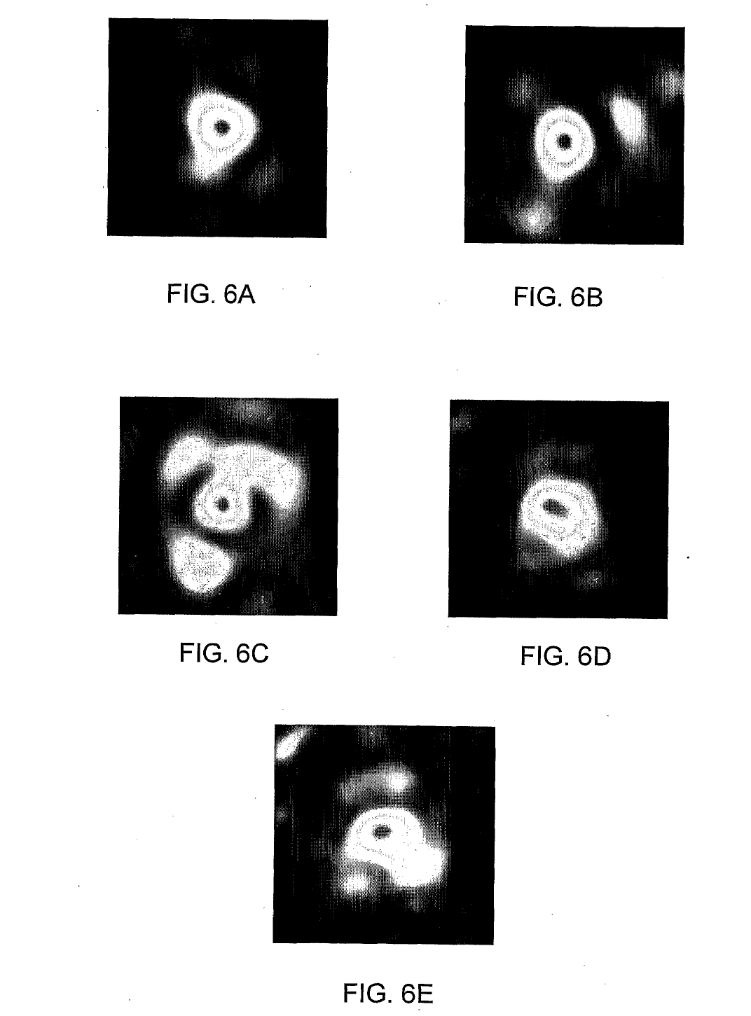

Computer simulation has been conducted to understand the effect of aberration caused by many data layers and to develop the methods for recording and reading and a structure of multi-layer nonlinear medium. First, the inventors have considered the effect of large phase masks in the optical path of a light beam (recording beam), where such a mask is placed either upstream or downstream of a focusing lens, with respect to the beam propagation direction. In the simulations conducted by the inventors, a focusing lens with a numerical aperture NA=0.5 was used. It should be noted that the simulation was relatively insensitive to the NA and that lower NA for regular diffractive gratings is a worse case scenario as the most efficient diffraction from regular gratings is formed by use of a collimated beam. In the simulation only the change in the intensity distribution was taken into account as scattering and reflection in the media are insubstantial. All the examples were simulated using a beam aperture of 1500 μm radius with intensity varying by about a factor 2.5 from the perimeter edge to the center (i.e., relatively small variation of intensity across the whole beam cross section prior to engaging the lens). The phase mask was placed between the aperture and the lens. Phase masks of different sizes, different phase shifts, and different positions with respect to the beam were considered and were superimposed in order to simulate the state of large patches of random phase deformations of the beam wave front. It appears that the results should be indicative of the effects observed for the multi layer structures of interest. FIGS. 6a-6c show the resulting focus peak images of several such simulation runs.

The phase shift masks might be an effectively equivalent, for example, to the effect of bumps and dips imperfections added to the focus lens. On a lens, if present, such bumps and dips may lead to diversion of some intensity focused to various locations finite distance from the main peak.

FIGS. 6d and 6e, being noticeably similar to FIGS. 6a-6b, show the result of multi-layer structure simulation (50 random layers).

The above is indicative of the following: For macroscopically random systems, the disorder and its effect are characterized by an intermediate scale of finite correlation length. Even in completely random scattering systems there is still a meaningful finite propagation correlation length. Similarly for the random phase deformations of the beam front, there is a characteristic correlation length. In more simple terms, there is always a continuous deformation, depending on how fast the variations are. There is some meso-scale (larger than micro-scale) on which the variation are small.

Considering the result of phase shift deformation across the beam diameter, resulting from propagation through the multi-layer disc structure, the following should be noted. Since the multi-layer structure has an internal order, e.g. using a certain set of mark sizes, distances between layer and track pitch the phase shifts will have substantial correlation length, and then a prominent effect will be similar to that of introducing finite size phase shift masks in the path of the beam.

The simulation results have shown that first random small multiple sub-peaks are scattered away from central focus peak and thus reducing intensity of the central focus peak, and only later (deeper in the medium) a widening of the central peak becomes significant. This can be seen in FIGS. 6a-6e.

In the above simulation of multi-layer structures each layer was composed from a combination of 4 gratings, each grating with a different period and orientation. For example, a 50 layer system is simulated using combinations of 200 different gratings.

More specifically, in the simulation the parameter ξ=(d/λ₁)Δn was used; for effective mark thickness d, the phase accumulated by a beam is exp[i2πd/λ]=exp[i2πdn/λ₀], where λ=λ₀/n. The relative phase shift accumulated between the parts of the beam front is going through the medium on layer is well approximated by exp[i2πξ]. The values of ξ relevant to the optical medium used in the simulation are in the range 0.005-0.05.

The following is observed with the increase of the number of layers through which the simulated beam is passing; (i) the intensity at the focus point is being reduced exponentially with the number of layers; (ii) first, peak width remains roughly constant, later, when significant phase deformation accumulates, the focused central peak starts to widen and even disintegrate into a widely scattered distribution. This is not observed before the peak intensity is reduced below 50% of the initial intensity. Thus, to have a medium that allows for many hundreds of layers of data with the same resolution very small refractive index change between the recoded marks and their surroundings is required. It should, however be noted that even very small refractive index changes, compensation for the reading intensity loss at focus might not be enough if similar data density in multiple layers is required. Generally speaking, for estimation of the practical number of layers, additional factors such as the accumulation of other system aberrations and the available power for recording to compensate for intensity loss at the focus should be taken into account. The exponential decay factor was estimated according to

$${P}_{N} = \frac{{I}_{N}}{{I}_{0}} = {u}^{N}$$

and one can thus find that

$$u = exp ( \frac{ln ( {P}_{N} )}{N} )$$

where P_{N} is the ratio of I_{N} the intensity at the focus spot (FWHN) to the initial intensity I₀ by using the simulation result for 10 layers to deduce the layer factor “u” for several different values of phase shifts ξ. Then, the respective values of u were used to predict the peak height after transmission through 30 and 50 layers, and compared with actual simulations of 30 and 50 layers. This is summarized in Table 1 (the layer number in superscript).

TABLE 1

| | | | | u¹⁰⁰ | u³⁰⁰ |
|---|---|---|---|---|---|
| ξ | u¹ | u³⁰ | u⁵⁰ | (extrapolated) | (extrapolated) |
| 0.004 | 0.99982 | 0.9946 | 0.9910 | 0.9822 | 0.9474 |
| 0.04 | 0.9935 | 0.8233 | 0.7232 | 0.5230 | 0.1431 |
| | | (0.8116) | (0.6998) | | |
| 0.1 | 0.9570 | 0.2679 | 0.1114 | 0.00012 | |
| | | (0.2695) | (0.1046) | | |
| 0.22 | 0.8054 | 0.00099 | | | |
| | | (0.00121) | | | |

The results, shown in Table 1 demonstrated better than 10% accuracy in terms of self-consistency and as shown below show reasonable fit to experiment. Therefore, the exponential dependence of the peak height reduction on the number layers is confirmed as a first approximation. The general formula u^{N} can be used for predicting the peak height in cases of any number of layers. The table shows such predictions for 100 and 300 layers.

It is thus evident that the focus peak intensity decays exponentially with the number of layers. For medium material having Δn=0.008, even 300 layers can be utilized without much problem. But, already at 100 layers the intensity is reduced by a factor ½. Therefore, when designing an optical data carrier with as much as possible data layers it is desirable to determine the value of “u” per layer to identify a practical limit on the controlled material property Δn magnitude for any particularly desired number N of layers.

The refractive index changes in the medium are very low therefore it is preferable to use alternate methods of measurements which reflect the refractive index change or the intensity loss per layer in more robust measurable ways.

The following are some examples of the experimental results of recording multiple layers in a non-linear medium and measurement of the effect of aberrations on the mark modulation depth. The media used comprised a monolithic plate of 10% w MeAA (Acrylic acid 3-{4-[1,2-dicyano-2-(4-methoxy-phenyl)-vinyl]-phenoxy}-propyl ester), 20% w eMMA (2-Methyl-acrylic acid 3-{4-[1,2-dicyano-2-(4-ethoxy-phenyl)-vinyl]-phenoxy}-propyl ester), 50% w TCLP (2-Methyl-acrylic acid 3-(2,4,6-trichloro-phenoxy)-propyl ester), 10% w EDGMA (poly(ethylene glycol) dimethacrylate), 10% w TBEC (tert-Butylperoxy 2-ethylhexyl carbonate) and 10% w MeMMA (2-Methyl-acrylic acid 3-{4-[1,2-dicyano-2-(4-methoxy-phenyl)-vinyl]-phenoxy}-propyl ester).

The recording scheme was optimized to record with very little amount of defects. The following parameters were used: NA 0.7; diode pumped solid state laser (crystaLaser) emitting at 671 nm with peak power (PP) 21 W and full width half maximum (FWHM) 22 ns; the pulse energy (PE) 460 nJ; mark recording rate of 66 mark/s; mark separation was 1.5 micron and mark's FWHM was as will be shown below around 0.6 micron providing a substantially fixed recording fill factor (in the recorded layer in the block) of around 16% (0.6 μm mark diameter (FWHM)/1.5 μm period) for each of the layer lateral dimensions; layer separation of 4-5 μm; and when more that one block is recorded, the distance between the blocks of 10 um.

When passing the recording process from block to block, a spherical aberrations corrector of the optical setup was appropriately adjusted. Small variations of the spherical aberration effect on the focus spot near optimal position of z-profile (optical axis of a recording beam when propagating towards the medium) make it possible to record three layers to each side of the optimized depth, thus allowing recording of seven layers in each block without readjusting the spherical aberration corrector. Using accurate pieso-electric actuator the lateral dimension of each recording block was limited to 100 micron by 100 micron.

The recording process was first tested for various parameters for recording one block (seven layers), until the recording process was repeatable.

Experiment 1—Recording of Two Blocks (14 Layers)

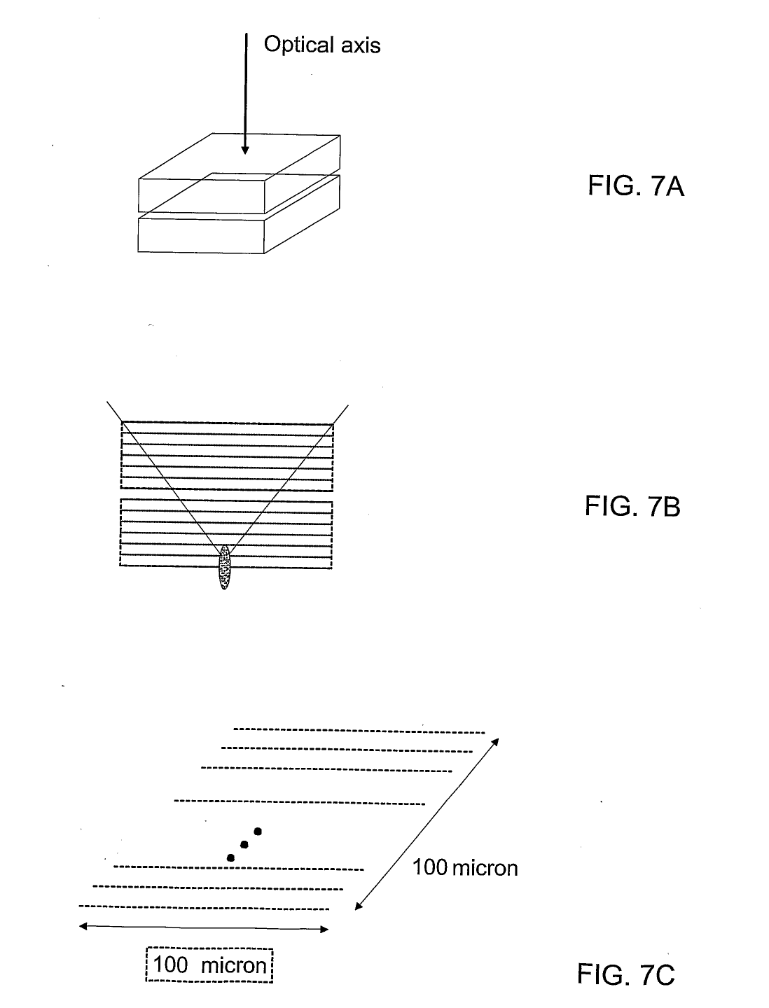

Reference is made to FIGS. 7A-7C, where FIG. 7A shows an optical data carrier formed by two blocks, each containing seven data layers, FIG. 7B shows schematically a recording scheme for recording those layers, and FIG. 7C shows the recording scheme for each separate layer. In this experiment, the medium mentioned above was used which has a refractive index n of about 1.5.

Since the optics NA is 0.7 and media refractive index is about 1.5, a recording beam focused in the medium volume has convergence angle θ of tan θ=0.5 (see FIG. 7B). In this connection, it should be noted that it is preferable to record the marks using a converging recording beam produced by optics of a large numerical aperture. This is because the beam should be preferably significantly defocused while it propagates to its focus spot, otherwise it may cause undesired recording. The use of multi-photon processes substantially ensures that any radiation out of the focus spot or out of focus of similar magnitude spots formed for example by efficient gratings has no effect on the medium.

Hence, when the recording beam is focused on the lowermost layer, all the rays of the recoding beam converging to the focus spot pass through about 10 recorded layers above said layer on which the recording beam is currently focused, while only some of the rays (i.e. central rays) pass through 3 upper layers. In other words, for those 10 layers, the fill factor of the layer cross section with the beam is the fill factor of the recorded layer. When the recording beam is focused in the middle of the lowermost layer, the additional 3 layers cover the beam partially.

Thus, using the recording procedure of this experiment it is possible to test a change of depth of modulation caused by the successive recording through 0 to 13 layers.

The results of such recording of 14 layers are summarized in Table 2

TABLE 2

| | Modulation | Mark FWHM |
|---|---|---|
| Layer # | Depth [%] | [um] |
| Block 1 | | |
| 1 | 10.6 | 0.55 |
| 2 | 11 | 0.6 |
| 3 | 11.4 | 0.6 |
| 4 | 8.9 | 0.53 |
| 5 | 8.4 | 0.61 |
| 6 | 9.7 | 0.6 |
| 7 | 8.45 | 0.52 |
| Block 2 | | |
| 8 | 6.7 | 0.63 |
| 9 | 7.3 | 0.55 |
| 10 | 6.3 | 0.68 |
| 11 | 9.44 | 0.64 |
| 12 | 8.7 | 0.53 |
| 13 | 8.5 | 0.47 |
| 14 | 8 | 0.46 |

As shown, the lowermost (last recorded) layer has depth of modulation 8% and the data mark size 0.46 μm. Statistically, a slow decrease, in depth of modulation per layer of 0.22%, is observed.

Experiment 2−Recording of 21 Layers (Three Blocks in Depth)

Reference is made to FIGS. 8A and 8B. FIG. 8A shows an optical data carrier formed by an arrangement of 8 blocks (each containing 7 layers, 100 μm by 100 μm), and one block centered below said 8-block arrangement. FIG. 8B shows more specifically the blocks' arrangement and a recording scheme to produce such a data carrier. This arrangement provides that when the recording beam is focused on the lowermost layer the recording and centered at the middle lower layer of the lower block, beam convergence results in the rays' passage through all the layers thereabove. The recording process begins from 4 upper blocks; then an objective setting is changed and 4 next blocks are recorded. After this the objective setting is again changed and the last block is recorded.

The results of such recording and sample reading of 21 layers are presented in Table 3

TABLE 3

| | | modulation, | |
|---|---|---|---|
| layer # | z piezo, um | % | block # |
| 1 | 6 | 13.5 | 4 |
| 2 | 11 | 10 | |
| 3 | 16 | 8.04 | |
| 4 | 21 | 7.9 | |
| 5 | 26 | 11.2 | |
| 6 | 31 | 8.3 | |
| 7 | 36 | 9.4 | |
| 8 | 51 | 7.7 | 8 |
| 9 | 56 | 11.45 | |
| 10 | 61 | 12.8 | |
| 11 | 66 | 13.2 | |
| 12 | 71 | 9.5 | |
| 13 | 76 | 8.74 | |
| 14 | 81 | 10.1 | |
| 15 | 53 | 7.8 | 9 |
| 16 | 58 | 7.36 | |
| 17 | 63 | 7.9 | |
| 18 | 68 | 8.1 | |
| 19 | 73 | 6.6 | |
| 20 | 78 | 8.2 | |
| 21 | 81 | 8.6 | |

As shown, the last layer has depth of modulation 8.6%. Statistically, there is a slow decrease in depth of modulation, i.e. of about 0.14% per layer.

Experiment 3-100 Layers Experiment

In this experiment, 14 seven-layer blocks and 2 more layers were sequentially recorded in a direction from the upper surface of the medium. At least one layer in each block was read after recording to ensure integrity of the recorded data.

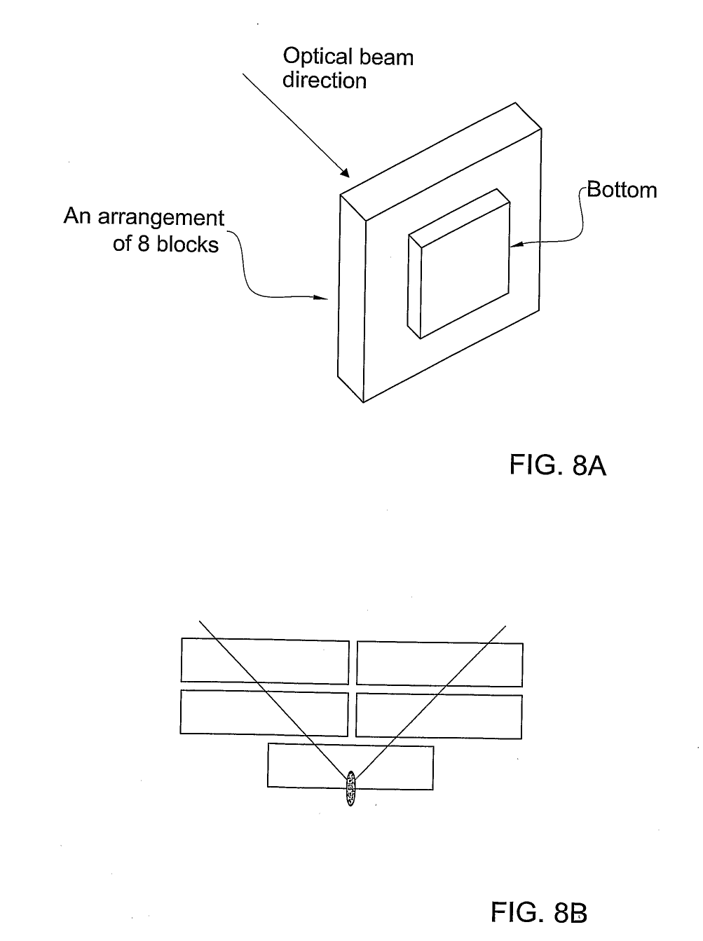

The recorded layers were sampled; the results for the depth of modulation and mark size are shown in Table 4. The change of depth of modulation is shown graphically in FIG. 9.

TABLE 4

| | | mark, |
|---|---|---|
| layer # | M, % | um |
| 1 | 11.28 | 0.61 |
| 4 | 15.42 | 0.64 |
| 7 | 12.62 | 0.6 |
| 8 | 10.35 | 0.55 |
| 11 | 13.38 | 0.49 |
| 14 | 10.55 | 0.66 |
| 15 | 8.3 | 0.49 |
| 18 | 8.23 | 0.52 |
| 21 | 10.98 | 0.47 |
| 28 | 9.3 | 0.65 |
| 35 | 8.98 | 0.55 |
| 42 | 10.15 | 0.52 |
| 49 | 9.62 | 0.58 |
| 56 | 8.5 | 0.56 |
| 63 | 9.41 | 0.46 |
| 70 | 10.35 | 0.6 |
| 77 | 10.15 | 0.55 |
| 84 | 9.28 | 0.58 |
| 91 | 11.09 | 0.63 |
| 98 | 11.1 | 0.49 |
| 100 | 10.6 | 0.49 |

As shown, the depth of modulation decreases with the medium depth at the beginning, and after ˜20 layers it seems to be stabilized near 10%. As the recording through many layers advances towards the recording of the 100th layer, the obscurence of the rays by the upper blocks/layers becomes insubstantial, as most of the rays reach the focus spot by passing the recorded stack of layers by the side. The amount of disturbance experienced by the beam during its propagation towards the focus spot approaches a steady value. The disturbance is more significant for the vertical rays than for those reaching the focus spot from aside. Two conclusions can be drawn from this experiment. The first is that for the top-to-bottom recording there will be a decrease of modulation depth, unless special measures (using longer recording pulses, higher laser power, etc) are taken to prevent it. The second is that for the bottom-to-top recording the modulation depth can be steady for an appropriately selected material, even if the same or close laser powers and the laser pulse durations are used for recording of different layers. The above two conclusions are supported by evaluating the two stages of the experiment: the initial and the steady, the former corresponding to the top-to-bottom recording, because for such recording the beam disturbance increases with each layer, and the latter physically corresponding to the bottom-to-top recording, because for such recording the beam disturbance is the same for each layer.

Thus, the present invention provides a novel optical data carrier and methods of data recording therein, allowing significant increase of the data layers and thus of the amount of stored information in the medium.

It should be noted that all the above recording strategies relate to medium which basic optical properties allow effective multi-layer recording enabling reading. In particular, the medium with the recorded data marks has low difference in refractive index between the recorded marks and the surrounding space. Also, the fluorescence emanated from the reading focus position would need to reach the detector with sufficiently small loss of intensity and minimal aberration, as the fluorescence signal is generally weak. Therefore the media should preferably minimally absorb the fluorescence signal, i.e. the medium should be such that its fluorescence signal wavelength is far from the (linear) absorption peaks of the medium to reduce aberrations formed by the fluorescent signal passage through many recorded layers. The fluorescence signal undergoing small aberrations may be detected by an imaging detector such as a 4-quad APD (an avalanche photo diode comprising 4 independent sections arranged in square or circle) or other position sensitive detectors. APD are capable for detecting low signals. Imaging detection or position sensitive detection may be used for tracking and focus error signal purposes.

The wavelength difference between the emission and absorption is to be differentiated from Stokes shift. The latter is the difference between the peak of linear absorption wavelengths that leads to fluorescence and the peak of the fluorescence. The difference between the emission and absorption referred to in this context is a wavelength difference between the fluorescence and any linear absorption wavelength peak whose oscillator strength is higher then 0.1.

Adequate criteria for the relationship between the interrogating wavelengths, emission and absorption are provided.

The low refractive index change between the recorded mark and the surrounding space in a specific wavelength is characterized by structural and compositional factors each contributing to the change of refractive index.

The requirements of the photo-active materials in the optical medium are characterized by a measurable criterion that is based on the Kramers-Kronig relationship. This criterion refers to the specific wavelengths and the closer absorbance peaks, consisting of the following:

The reading wavelength is far from the closest absorbance peaks, preferably more than 150 nm from the absorbance peaks whose oscillator strength is more than 0.1, more preferably more than 200 nm away from such absorbance peaks. High overlap is to be between the absorption spectra of the photo-active materials comprising the at least two states (unrecorded space and different marks). Fluorescence is far from the closest absorbance peaks, preferably more than 50 nm from the absorbance peaks whose oscillator strength is more than 0.1, more preferably more than 70 nm away from such absorbance peaks and even more preferably more than 100 nm away from such absorbance peaks.

It should be understood that absorbance overlap can be quantified by a term absorbance dissimilarity which is complementary to this absorbance overlap. For the purposes of this disclosure, this absorbance dissimilarity is operatively defined relative to the specific interrogating (exciting) wavelength in the wavelength range of 350 nm, in each direction around the interrogating wavelength, according to the following equation

$$D = 1 - \frac{{e}_{min}}{{e}_{max}} , \\ {e}_{i} = {\int }_{L}^{U} \frac{{ɛ}_{i} ( ω )}{{ω}^{2} - {Ω}^{2}} d ω ,$$

where D is the absorbance dissimilarity; εᵢ(ω) is the wavelength dependent absorption coefficient of the respective material, measured during light passage through a solution of the photo-active materials; Ω is the interrogating frequency; and L and U are the respective lower and upper limits of the relevant wavelength range.

The above operative definition enables the comparison of different materials by numerical estimation of the absorbance dissimilarity from the measured absorbance spectra.

The absorbance dissimilarity for multilayer optical storage between the spectra of the materials should be substantially less than 0.4, preferably less than 0.25, at and most preferably less than 0.15.

The above mentioned criteria are important for reading system that can facilitate compensation for aberrations caused by detecting fluorescent signal through many layers; and improve the ability to read by first reducing the amount of aberrations of the reading beam and secondly reducing the amount of aberrations of a fluorescence signal thereby allowing better collection imaging of the signal onto a position sensitive detector.

### EXAMPLE A1

A polymer is produced in which the photochromic groups are linked to the polymeric matrix, either pending or in the polymeric backbone. By an embodiment of the invention, the polymer is a homopolymer or a co-polymer comprised of polymerizable active chromophore monomer.

Preferably, the polymer is a polymethylmethacylate based polymer wherein the active chromophoric groups are stilbene derivatives of the following formula (I):

Ar¹C(R¹)═C(R²)Ar² (I)

wherein Ar¹ and Ar² are phenyl groups optionally independently substituted and wherein R¹ and R² are strongly absorbing in the IR or; or wherein Ar¹ and Ar² are phenyl groups optionally independently substituted with one or more groups selected from —C₁₋₆alkyls, —OC₁₋₆alkyl, —SC₁₋₆alkyl and, —C₁₋₆ OH, thiols and their salts, NR′R″, R′ and R″ being independently hydrogen or C₁₋₆alkyl; R¹ and R² are substituents selected from nitriles selected from —(CH₂)ₙCN, n being 0, 1 or 2, halides, carboxylic acids, their esters, or a nitro compound selected from —(CH₂)ₙNO₂, n being 0, 1 or 2. C₁₋₆ alkyls may be straight or branched alkyls, preferably a methyl, ethyl, propyl, isopropyl, butyl, sec-butyl or tert-butyl as well as pentyl groups; the nitrile is preferably a —CN group and the nitro compound is preferably an —NO₂ group.

Alternatively the compounds can be of formula (VII)

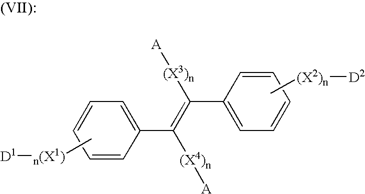

wherein n is independently 0, 1 or 2; X¹, X², X³ and X⁴ are conjugated groups, each of which is independently selected from (i) 5 or 6-membered aromatic moieties which may also contain one, two or three heteroatoms selected from N, O or S, and (ii) C₂-C₅ alkenylenes or C₂-C₅ alkynylenes or their heteroatom chain analogs which optionally may comprise a N, O or S atom in the chain; one or both of said X¹ and X² may be bound to the 3, 4 or 5 positions of the phenyl ring, or one or both of said X¹ and X² may form a fused ring with the phenyl ring in the 3-4 or 4-5 positions; D¹ and D² are electron donor moieties independently selected from —C₁₋₄alkyls, —OC₁₋₄alkyl, —SC₁₋₄alkyl and, —C₁₋₄OH, thiols and their salts, NR′R″, R′ and R″ being independently hydrogen or C₁₋₄alkyl, biphenyls, and heteroaromatics selected from five- and six-member rings having one or two heteroatoms selected from N, O or S; A is an electron acceptor moiety selected independently from pyridinium, ammonium salts, C₂₋₅alkenyl or C₂₋₅alkynyl groups, azobenzenes, C₁₋₄CN, halides, C₁₋₆COOH or their C₁₋₆esters, or C₁₋₄NO₂ compounds.

A polymerizable active chromophore monomer useful in accordance with the invention is preferably a compound of the following formula (II):

Ar¹C(R¹)═C(R²)Ar²-M (II)

wherein Ar¹, Ar², R¹ and R² are as defined above and M is a polymerizable monomeric moiety. Specific example of M are acrylic monomers such as methylmethacrylate (MMA) and methylacrylate (MA) derivatives or a styrene-based monomer.

Exemplary photochromic-modified monomers are those of the following formula (III):

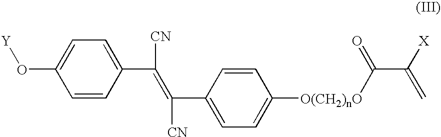

wherein X is methyl or hydrogen; n is an integer of 2 to 7; Y is hydrogen or a linear or branched alkyl moiety having 1 to 8 carbon atoms optionally substituted with halogens.

Particular examples are polymerizable active chromophore monomers of the following formula (IV) and (V) (also referred to herein as “eMMA” and “eAA”, respectively):

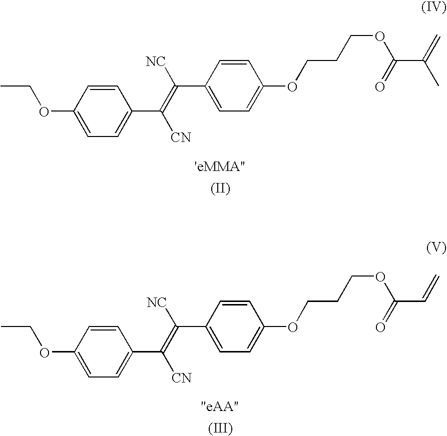

Another example is a styrene-based monomer of formula (VI):

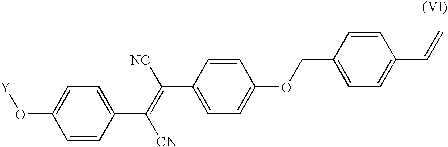

wherein Y is as defined above. A preferred Styrene derivative is that in which Y is ethyl.

The derivatives of the compound of formula (I) and in particular the compound (“eMMA”) preferably used according to the present invention is photoisomerizable between trans and cis configurations. The trans configuration is characterized by (i) a much higher fluorescence than the cis; (ii) the trans configuration has a large 2-photon absorption cross-section; (iii) similar one-photon absorption. These features allow it to be used in a 3D memory, by 2-photon excitation.

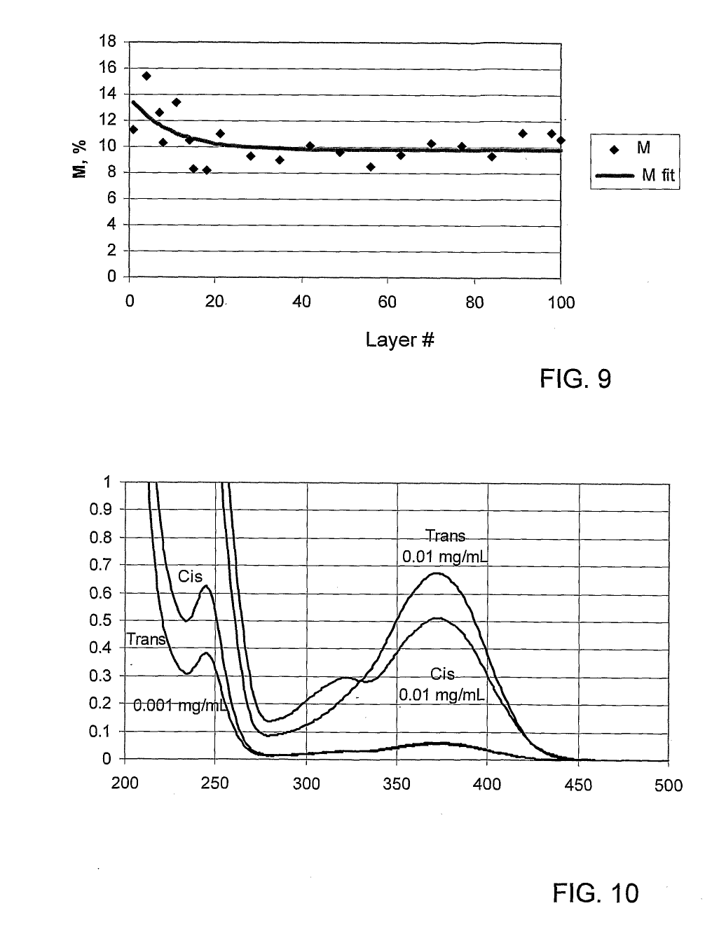

The compound has a two-photon absorption peak around 650 nm and may be interrogated at wavelength around 650 by use of laser diodes similar to those used for DVD applications, the medium comprising the material is substantially transparent from 500 nm to about 1000 nm with substantial abortion peaks at around 370 nm (FIG. 10), with very little overlap difference between its absorbance (maximum at 375 nm) and emission (maximum at 485 nm) spectra, the absorbance dissimilarity is 0.15, and with a high Stokes shift of over 100 nm (fluorescence peak is at about 500 nm) This means that it may be used for reading data through many layers before aberrations of read beam or the emission becomes a serious problem.

While the exemplary embodiments of the present method has been illustrated and described, it will be appreciated that various changes can be made therein without affecting the spirit and scope of the method. The scope of the method, therefore, is defined by reference to the following claims.

1. A non-linear optical data carrier for recording therein information defined by a pattern of spaced-apart marks arranged in virtual data layers, the data carrier comprising a medium comprising a substance capable of being excited by a first multi-photon process to be switched from its first state into a second state, where the first and second states of the substance provide different response signals to a second multi-photon interaction, the substance when in the first and second states having substantially overlapping linear absorption wavelength peaks, and first and second wavelengths involved in said first and second multi-photon processes and the response signals wavelengths being outside the linear absorption spectrum peaks of the substance in its first and second states, said non-linear optical storage medium allowing creation therein of the multiple data layers.

2. A non-linear optical data carrier according to claim 1, wherein the response signal is a fluorescent signal.

3. A non-linear optical data carrier according to claim 1, wherein the wavelength of the response signal is at least 50 nm longer than a wavelength of the linear absorption peak of said medium.

4. A non-linear optical data carrier according to claim 1, wherein the wavelength of the response signal is at least 70 nm longer than a wavelength of the linear absorption peak of said medium.

5. A non-linear optical data carrier according to claim 1, wherein the wavelength of the response signal is at least 100 nm longer than a wavelength of the linear absorption peak of said medium.

6. A non-linear optical data carrier according to claim 1, having an upper surface and the multiple data layers containing a plurality of the spaced-apart recorded marks, the recorded marks being configured with substantially the same basic depth of modulation for the multiple data layers.

7. A non-linear optical data carrier according to claim 1, having an upper surface and the multiple data layers containing a plurality of the spaced-apart recorded marks, the recorded marks being configured with increasing basic depth of modulation in the data layers in a direction from the upper surface of data carrier.

8. A non-linear optical data carrier according to claim 7, wherein the recorded marks of the multiple layers and the spaces between the recorded marks are characterized by at least one of the following: (a) substantially the same basic size of the recorded marks and increased level of the state concentration profile in the multiple data layers in a direction from an upper surface of the data carrier by which it is to be exposed to a reading beam, and (b) substantially the same basic size of the spaces, for the multiple data layers.

9. A non-linear optical data carrier according to claim 5, wherein the recorded marks of the multiple layers and the spaces between the recorded marks are characterized by at least one of the following: substantially the same basic size of the recorded marks and substantially the same basic size of the spaces, for the multiple data layers.

10. A non-linear optical data carrier according to claim 5, wherein the pattern of the recorded marks in at least one first layer and at least one second layer which is more proximal to the upper surface of the medium than said first layer is characterized by at least one of the following: the basic size of the mark is larger in the first data layer than in the second data layer; and the basic size of the space is larger in the first data layer than in the second data layer.

11. A non-linear optical data carrier according to claim 5, wherein said data layers comprise an arrangement of blocks each including the multiple data layers, a separation between the blocks being larger than a separation between the data layers of the same block.

12. A non-linear optical data carrier according to claim 5, comprising about 35-70 of said data layers.

13. A non-linear optical data carrier according to claim 5, comprising about 71-150 of said data layers.

14. A non-linear optical data carrier for recording therein information defined by a pattern of spaced-apart marks arranged in virtual data layers, the medium comprising a substance capable of being excited by a first multi-photon process to be switched from its first state into a second state different in its optical interaction with a second multi-photon process, where the substance when in the first and second states have small absorbance dissimilarity.

15. A non-linear optical data carrier for recording therein information defined by a pattern of spaced-apart marks arranged in virtual data layers, the medium comprising a substance capable of being excited by a first multi-photon process to be switched from its first state into a second state different in its optical interaction with a second multi-photon process, where the substance when in the first and second states have small absorbance dissimilarity, said non-linear optical storage medium having multiple recorded data layers configured with substantially the same basic depth of modulation for the multiple data layers.

16. A non-linear optical data carrier for recording therein information defined by a pattern of spaced-apart marks arranged in virtual data layers, wherein the pattern of the recorded marks in at least one first layer and at least one second layer which is more proximal to an upper surface of the medium, by which the data carrier is to be exposed to a reading beam, than said first layer is characterized by at least one of the following: the basic size of the mark is larger in the first than in the second layer; and the basic size of the space is larger in the first layer than in the second layer.

17. Method of recording data in a three-dimensional optical data storage medium, recordable by multi-photon absorption process, the method comprising illuminating the medium by a recording light beam, entering the medium from an upper surface thereof, while generally monotonically changing a focal plane depth of the recording beam in a certain general recording direction, to record a pattern of spaced-apart marks arranged in multiple virtual data layers.

18. A method according to claim 17, wherein the recording of the multiple data layers is carried out with substantially constant intensity of the recording light beam.

19. A method according to claim 17, wherein the recording of the multiple data layers comprises creating substantially the same basic depth of modulation for the multiple data layers.

20. A method according to claim 17, wherein the recording of the multiple data layers comprises creating the basic depth of modulation for the multiple data layers substantially increased in a direction from said upper surface.

21. A method according to claim 20, wherein the recording comprises increasing a level of the fluorescent state concentration profile contrast in the multiple data layers in the direction from the upper surface.

22. A method according to claim 20, wherein the recording of the multiple data layers comprises providing a longer recording event to record at least the basic marks in at least one first layer than that of at least one second layer being closer to the upper surface of the medium than the first layer.

23. A method according to claim 20, wherein the recording of the multiple data layers comprises providing a larger time gap between the recording events when creating at least a basic space size in at least one first layer than in at least one second layer being closer to the upper surface of the medium than the first layer.

24. A method according to claim 22, wherein said recording comprises maintaining substantially the same speed of a relative displacement between the recording beam and the optical medium.

25. A method according to claim 22, wherein said recording comprises using a smaller speed of a relative displacement between the recording beam and the optical medium when recording in the at least one first layer than in the at least one second layer.

26. A method according to claim 17, wherein the recording of the multiple data layers comprises successively recording multiple blocks of the data layers while monotonically changing the focal plane depth of the recording beam in between the blocks in said general recording direction.

27. A method according to claim 26, wherein the recording of the multiple data layers comprises recording the data layers of the block arbitrarily changing the recording direction.

28. A method according to claim 26, wherein a distance between each two locally adjacent blocks is larger than a distance between the layers of the same block.

29. A method according to claim 26, wherein the recording of the multiple data layers comprises displacing aberration correcting optics while changing the focal plane depth of the recording beam from block to block.

30. A method according to claim 17, wherein said generally monotonically changing the focal plane depth comprises monotonically changing the focal plane depth in said general recording direction.

31. A method according to claim 30, wherein said general recording direction is from said upper surface towards a lower surface of the medium.

32. A method according to claim 30, wherein said general recording direction is from a lower surface towards said upper surface of the medium.

33. A method according to claim 17, wherein a width of the recording beam is selected to be larger than a width of a beam to be used for reading said data layer.
